(19) United States
(12) Patent Application Publication
(10) Pub. No.: US 2025/0036268 A1
(43) Pub. Date: Jan. 30, 2025

(54) METHOD AND APPARATUS FOR INTERACTIVE VIRTUAL LEARNING SYSTEM, STORAGE MEDIUM, AND ELECTRONIC DEVICE

(71) Applicant: TENCENT TECHNOLOGY (SHENZHEN) COMPANY LIMITED, Shenzhen (CN)

(72) Inventors: Liming KONG, Shenzhen (CN); Yingqiu QU, Shenzhen (CN); Qien DONG, Shenzhen (CN)

(73) Assignee: TENCENT TECHNOLOGY (SHENZHEN) COMPANY LIMITED, Shenzhen, GD (CN)

(21) Appl. No.: 18/914,900

(22) Filed: Oct. 14, 2024

Related U.S. Application Data
(63) Continuation of application No. PCT/CN2023/117935, filed on Sep. 11, 2023.

(30) Foreign Application Priority Data
Oct. 20, 2022 (CN) 202211289111.X

(51) Int. Cl. G06F 3/0484; G06F 3/04815; G06F 3/14; G09B 5/02

(52) U.S. Cl. CPC G06F 3/0484; G06F 3/04815; G06F 3/1454; G09B 5/02

(57) ABSTRACT

In a virtual learning method, a setting interface for inputting information is displayed when a seating request is triggered by a first user on a first user interface. The first user interface is associated with a virtual learning system. Information about at least one second user that is associated with the virtual learning system is obtained. When the at least one second user is matched to the inputted information input by the first user, a second user interface is displayed. The second user interface includes a first virtual object corresponding to the first user and at least one second virtual object corresponding to the at least one second user. The first virtual object and the at least one second virtual object both are bound to a first virtual multi-user seat.

### RELATED APPLICATIONS

The present application is a continuation of International Application No. PCT/CN2023/117935, filed on Sep. 11, 2023, which claims priority to Chinese Patent Application No. 202211289111.X, filed on Oct. 20, 2022. The entire disclosures of the prior applications are hereby incorporated by reference.

### FIELD OF THE TECHNOLOGY

This disclosure relates to the computer field, including to a method and an apparatus for implementing a virtual learning system, a storage medium, and an electronic device.

### BACKGROUND OF THE DISCLOSURE

With research and progress of an artificial intelligence technology, the artificial intelligence technology is researched in and applied to a plurality of fields such as a common smart home, a smart wearable device, a virtual assistant, a smart speaker, smart marketing, unmanned driving, automatic driving, an unmanned aerial vehicle, a robot, smart medical care, and smart customer service. With the development of technologies, the artificial intelligence technology is to be applied to more fields, and plays an increasingly important role.

A virtual learning system, for example, a virtual self-learning room system, is also referred to as a virtual self-learning room, and refers to a learning environment constructed by using a multimedia communication technology on a computer network, to allow students at different locations to perform learning activities. For example, in a scenario of a virtual self-learning room, a user may complete self-learning online.

### SUMMARY

Embodiments of this disclosure provide a method and an apparatus for implementing an interactive virtual learning system, a non-transitory computer-readable storage medium, and an electronic device, to enable different users at different locations to implement online learning activities by using the virtual learning system, thereby improving interaction efficiency.

According to an aspect of this disclosure, a virtual learning method is provided. In the method, a setting interface for inputting information is displayed when a seating request is triggered by a first user via a first user interface. The first user interface is associated with a virtual learning system. Information about at least one second user that is associated with the virtual learning system is obtained. When the at least one second user is matched to the inputted information input by the first user, a second user interface is displayed. The second user interface includes a first virtual object corresponding to the first user and at least one second virtual object corresponding to the at least one second user. The first virtual object and the at least one second virtual object both are bound to a first virtual multi-user seat.

According to an aspect of this disclosure, an information processing apparatus is provided. The apparatus includes processing circuitry configured to display a setting interface for input information when a seating request is triggered by a first user on a first user interface. The first user interface is associated with a virtual learning system. The apparatus includes processing circuitry configured to obtain information about at least one second user that is associated with the virtual learning system. When the at least one second user is matched to the inputted information inputted by the first user, the processing circuitry is configured to display a second user interface that includes a first virtual object corresponding to the first user and at least one second virtual object corresponding to the at least one second user. The first virtual object and the at least one second virtual object both are bound to a first virtual multi-user seat.

According to an aspect of this disclosure, a non-transitory computer-readable storage medium is provided. The non-transitory computer-readable storage medium stores instructions which when executed by a processor cause the processor to perform the virtual learning method.

According to an aspect of this disclosure, a computer program product or a computer program is provided. The computer program product or the computer program includes computer instructions, and the computer instructions are stored in a non-transitory computer-readable storage medium. A processor of a computer device reads the computer instructions from the computer-readable storage medium, and the processor executes the computer instructions, to enable the computer device to perform the virtual learning method.

According to an aspect of this disclosure, an electronic device is further provided. The electronic device includes a memory, a processor, and a computer program stored in the memory and executable on the processor. The processor performs the virtual learning method through the computer program.

### BRIEF DESCRIPTION OF THE DRAWINGS

FIG. 1 is a schematic diagram of an application environment of a method for implementing a virtual learning system according to an embodiment of this disclosure.

FIG. 2 is a schematic flowchart of a method for implementing a virtual learning system according to an embodiment of this disclosure.

FIG. 3 is a schematic diagram of a method for implementing a virtual learning system according to an embodiment of this disclosure.

FIG. 4 is a schematic diagram of another method for implementing a virtual learning system according to an embodiment of this disclosure.

FIG. 5 is a schematic diagram of another method for implementing a virtual learning system according to an embodiment of this disclosure.

FIG. 6 is a schematic diagram of another method for implementing a virtual learning system according to an embodiment of this disclosure.

FIG. 7 is a schematic diagram of another method for implementing a virtual learning system according to an embodiment of this disclosure.

FIG. 8 is a schematic diagram of another method for implementing a virtual learning system according to an embodiment of this disclosure.

FIG. 9 is a schematic diagram of another method for implementing a virtual learning system according to an embodiment of this disclosure.

FIG. 10 is a schematic diagram of another method for implementing a virtual learning system according to an embodiment of this disclosure.

FIG. 11 is a schematic diagram of another method for implementing a virtual learning system according to an embodiment of this disclosure.

FIG. 12 is a schematic diagram of another method for implementing a virtual learning system according to an embodiment of this disclosure.

FIG. 13 is a schematic diagram of another method for implementing a virtual learning system according to an embodiment of this disclosure.

FIG. 14 is a schematic diagram of another method for implementing a virtual learning system according to an embodiment of this disclosure.

FIG. 15 is a schematic diagram of another method for implementing a virtual learning system according to an embodiment of this disclosure.

FIG. 16 is a schematic diagram of another method for implementing a virtual learning system according to an embodiment of this disclosure.

FIG. 17 is a schematic diagram of another method for implementing a virtual learning system according to an embodiment of this disclosure.

FIG. 18 is a schematic diagram of an apparatus for implementing a virtual learning system according to an embodiment of this disclosure.

FIG. 19 is a schematic diagram of a structure of an electronic device according to an embodiment of this disclosure.

### DETAILED DESCRIPTION

To aid a person skilled in the art better understand solutions of this disclosure, the following describes this disclosure with reference to the accompanying drawings in more detail. The described embodiments are merely an example rather than all of the embodiments of this disclosure. Other embodiments obtained by a person of ordinary skill in the art based on the embodiments of this disclosure shall fall within the protection scope of this disclosure.

In the specification, claims, and accompanying drawings of this disclosure, terms “first”, “second”, and the like are intended to distinguish between similar objects, but do not necessarily indicate a specific order or sequence. Data used in this way may be interchanged in an appropriate case, so that the embodiments of this disclosure described herein can be implemented in other orders than the order illustrated or described herein. In addition, terms “include”, “have”, and any other variants thereof are intended to cover a non-exclusive inclusion. For example, a process, method, system, product, or device that includes a list of operations or units is not limited to those expressly listed operations or units, but may include other operations or units not expressly listed or inherent to the process, method, product, or device. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The descriptions of the terms are provided as examples only and are not intended to limit the scope of the disclosure.

Virtual learning space: The virtual learning space refers to a virtual learning region provided in a virtual learning system, for example, a virtual self-learning room. The virtual learning space is a learning environment constructed by using a multimedia communication technology on a computer network, to allow students at different locations to perform learning activities.

Virtual multi-user seat: The virtual multi-user seat refers to a virtual seat in virtual learning space (for example, a virtual self-learning room), and includes at least two seats that can seat at least two users. For example, the virtual multi-user seat may have a plurality of parameters, such as an identifier of the virtual multi-user seat, and seat numbers and status respectively corresponding to a plurality of seats included in the virtual multi-user seat. When a user chooses to have a seat, the identifier of the virtual multi-user seat and a seat number of the seat that seats the user may be bound to a user identifier of the user, and a state of the seat is set to occupied. When a user leaves the virtual learning space, a previously bound virtual multi-user seat may be unbound, that is, a binding relationship between the identifier of the virtual multi-user seat, a seat number, and a user identifier is unbound, and a state of the seat is set to available.

The examples of this disclosure involve a technology such as a computer vision technology of artificial intelligence and are specifically described by using the following embodiments.

An embodiment of this disclosure provides a method for implementing a virtual learning system. In an implementation, the method for implementing a virtual learning system may be applied to, but is not limited to, an environment shown in FIG. 1. A computer device may include, but is not limited to, user equipment 102 and a server 112. The user equipment 102 may include, but is not limited to, a display 104, a processor 106, and a memory 108. The server 112 includes a database 114 and a processing engine 116.

A process may include the following operations.

Operation S102: The user equipment 102 displays a seating button 1006 on a first user interface 1004 associated with virtual learning space 1002 provided by a virtual learning system, and obtains a seating request triggered for the seating button 1006. The first user interface 1004 is an interface before a first user joins the virtual learning space 1002, the virtual learning space 1002 includes a virtual multi-user seat 1008 that allows at least two virtual objects to sit in together, the seating request carries matching expectation information set by the first user, the matching expectation information set by the first user is configured for matching expectation information corresponding to a virtual object sitting together with the first virtual object in the virtual multi-user seat, and the first virtual object is a virtual character of the first user.

Operation S104 and S106: Transmit the seating request to the server 112 through a network 110.

Operation S108 and S110: The server 112 performs matching, by using the processing engine 116 based on the matching expectation information set by the first user, on candidate users corresponding to the virtual learning space 1002 stored in the database 114, to obtain at least one second user.

Operation S112 and S114: Transmit indication information about at least one second virtual object corresponding to the at least one second user to the user equipment 102 through the network 110.

Operation S116: The user equipment 102 generates, by using the processor 106 based on the indication information, and outputs, by using the display 104, a second user interface including the first virtual object and the at least one second virtual object. In the second user interface, the first virtual object and the at least one second virtual object sit together in the virtual multi-user seat 1008, and the indication information about the at least one second virtual object is stored in the memory 108.

In addition to the example shown in FIG. 1, the foregoing operations may be completed independently by the user equipment 102 or the server 112, or may be completed by the user equipment 102 and the server 112 in collaboration. For example, the user equipment 102 performs operations such as obtaining the second virtual object, thereby reducing a processing pressure on the server 112. The user equipment 102 includes, but is not limited to, a handheld device (such as a mobile phone), a laptop computer, a desktop computer, a vehicle-mounted device, or the like. A specific implementation of the user equipment 102 is not limited in this disclosure.

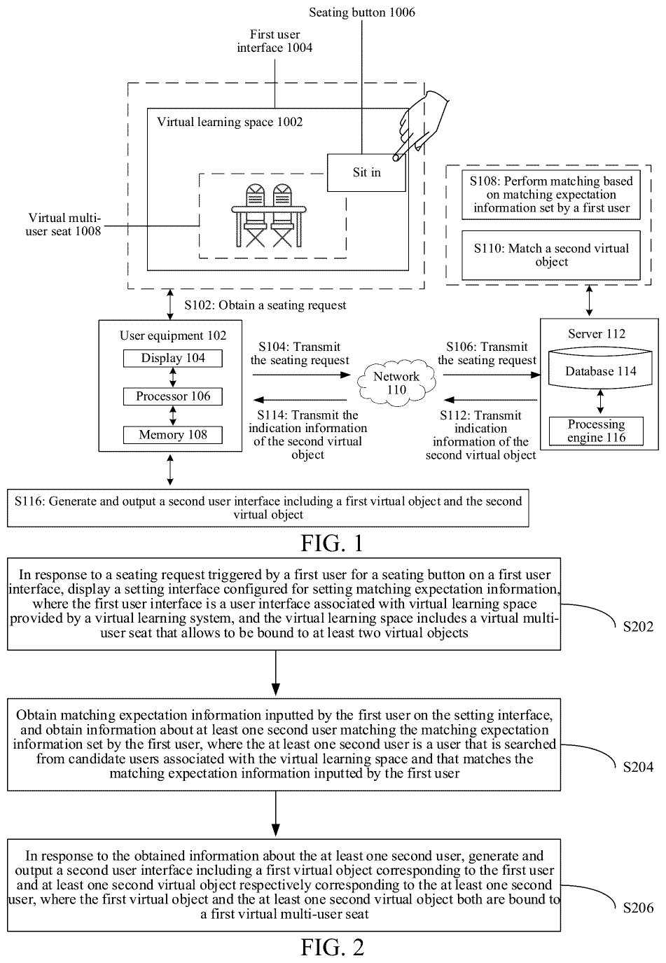

In an example, as shown in FIG. 2, a method for implementing a virtual learning system includes the following operations.

S202: In response to a seating request triggered by a first user for a seating button on a first user interface, display a setting interface configured for setting matching expectation information, where the first user interface is a user interface associated with virtual learning space provided by a virtual learning system, and the virtual learning space includes a virtual multi-user seat that allows to be bound to at least two virtual objects.

S204: Obtain matching expectation information inputted by the first user on the setting interface, and obtain information about at least one second user matching the matching expectation information set by the first user, where the at least one second user is a user that is searched from candidate users associated with the virtual learning space and that matches the matching expectation information inputted by the first user.

S206: In response to the obtained information about the at least one second user, generate and output a second user interface including a first virtual object corresponding to the first user and at least one second virtual object corresponding to the at least one second user, where the first virtual object and the at least one second virtual object both are bound to a first virtual multi-user seat.

In some examples, the method for implementing a virtual learning system may be applied to, but is not limited to, an online learning scenario. For example, when a user selects online learning, the user may control, through a user interface in an application program of a virtual learning system, a virtual character thereof to perform self-learning in virtual learning space, to simulate a real-world learning environment.

This embodiment of this disclosure provides a desk mate concept. To be specific, another virtual object suitable for a user is matched for the user, for example, a virtual character controlled by another user is matched for the user, to simulate a real-world environment in which two or more people learn together.

In addition, for how to match the user with a suitable virtual object, this embodiment records a technical means by which matching expectation information can be set by the user. By using the technical means, the user can be matched with an expected virtual object.

In some embodiments, the virtual object may be understood as, but is not limited to, an object displayed in the virtual learning system, such as a virtual image, a virtual item, or a virtual character.

In some embodiments, the virtual learning space may be understood as, but is not limited to, a virtual environment of online learning. The virtual learning space is configured for simulating a real environment of offline learning, for example, a spatial region having a learning attribute such as a virtual library, a virtual learning house, or a virtual self-learning room. In addition, the virtual learning space is not limited to indoors or outdoors, and an outdoor environment may also be set to the virtual learning space. Furthermore, the virtual learning space may include, but is not limited to, a plurality of virtual multi-user seats.

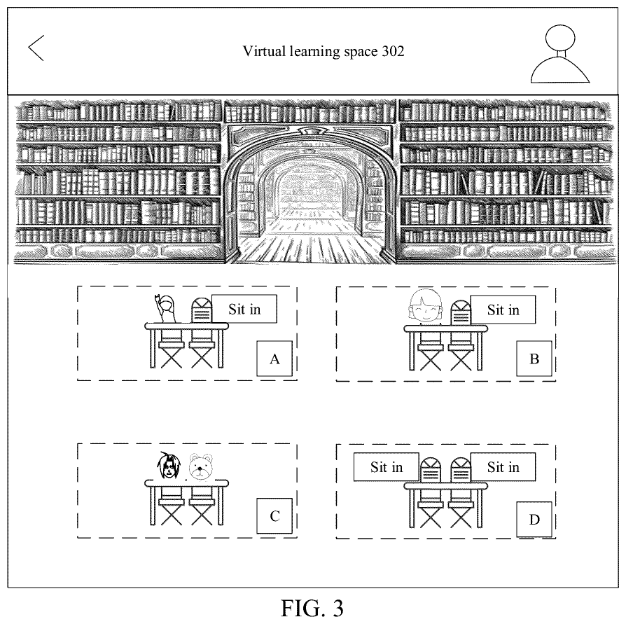

Further, for example, as shown in FIG. 3, virtual learning space 302 is set to a virtual library having a learning attribute. The virtual library (the virtual learning space 302) includes a plurality of virtual multi-user seats, such as a virtual multi-user seat A, a virtual multi-user seat B, a virtual multi-user seat C, and a virtual multi-user seat D. Both the virtual multi-user seat A and the virtual multi-user seat B have been sat in by (bound to) one virtual object, the virtual multi-user seat C has been sat in by two virtual objects, and the virtual multi-user seat D has not been sat in by any virtual object.

In addition, “sit in” may be used to, but is not limited to, represent a seating button associated with each virtual multi-user seat that still allows to be sat. For example, both the virtual multi-user seat A and the virtual multi-user seat B have been sat in by one virtual object, but an upper limit is to be sat in by two virtual objects. Therefore, both the virtual multi-user seat A and the virtual multi-user seat B allow to be sat in by another virtual object, and then each of the two seats displays one associated seating button. Similarly, the virtual multi-user seat D has not been sat in by any virtual object, and therefore, the virtual multi-user seat D displays two associated seating buttons. In contrast, the virtual multi-user seat C has been sat in by two virtual objects, and an upper limit has been reached. Therefore, the virtual multi-user seat C does not display an associated seating button.

In some embodiments, the first user interface is an interface before the first user joins the virtual learning space. A relationship between the first user interface and the virtual learning space may be understood as, but is not limited to, that the first user interface is configured for displaying a picture and another virtual element in the virtual learning space. The another virtual element may be a virtual button for control (for example, a seating button), text/image information for prompting the user (for example, avatar information of the first user and name information of the virtual learning space), and the like.

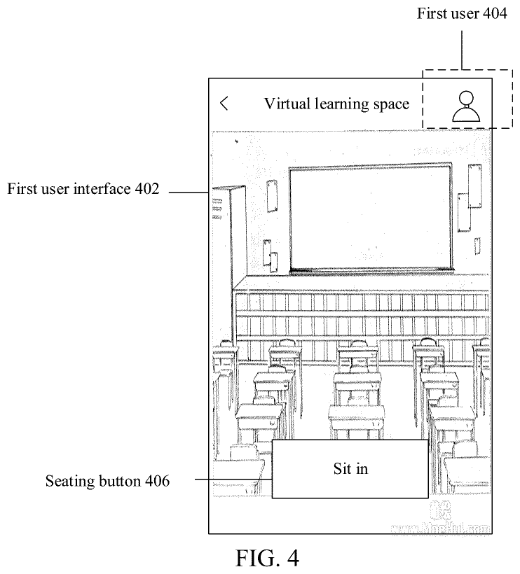

Further, for example, as shown in FIG. 4, name information of virtual learning space, environment information of the virtual learning space, avatar information of a first user 404, and a seating button 406 are displayed on a first user interface 402. The seating button 406 shown in FIG. 4 may be understood as, but is not limited to, a seating button configured for triggering tap-for-seat. After the first user triggers a seating request for the seating button 406, in response to the seating request, a virtual multi-user seat is determined from virtual multi-user seats in an available state in the virtual learning space. In other words, the user actively triggers the seating request, but passively selects a virtual multi-user seat to sit in.

As shown in FIG. 3, the user may actively select, from the virtual multi-user seats in the available state in the virtual learning space, a virtual multi-user seat to sit in. For example, a seating request is triggered for a seating button associated with the virtual multi-user seat A, to request to sit in the virtual multi-user seat A. For another example, a seating request is triggered for a seating button associated with the virtual multi-user seat D, to request to sit in the virtual multi-user seat D, that is, the virtual multi-user seat D is determined as the virtual multi-user seat.

In some embodiments, the matching expectation information set by the first user is configured for matching expectation information corresponding to a virtual object sitting together with the first virtual object in the virtual multi-user seat. In other words, the first user may determine, based on the set matching expectation information, an ideal desk mate, or an ideal object to learn together with. The matching expectation information may be understood as, but is not limited to, a matching condition set by the first user. For example, when the first user sets the matching condition to including an age from 20 to 25, a user with an age less than 20 or greater than 25 does not satisfy the matching condition. In other words, the user is not the ideal object for the first user to learn together with, that is, the user does not match the first user.

Specifically, the matching expectation information may limit, but is not limited to, various types of information, such as an age, a school, an academic qualification, a height, a constellation, an adept discipline, a discipline for exam, learning content, a hobby interest, and a learning objective. In addition, to improve setting efficiency of the matching expectation information and processing efficiency of the matching operation, a plurality of candidate labels may also be provided to the first user, and this is not limited. In this way, the first user may select a label as the matching condition from the plurality of candidate labels, and when a label selected by another user matches the label as the matching condition, the user is considered to match the first user, that is, the user is determined as the ideal object for the first user to learn together with.

In some embodiments, the at least one second virtual object may be understood as, but is not limited to, that a quantity of second virtual objects is greater than or equal to one. In other words, there may be one second virtual object or a plurality of second virtual objects, and the quantity may be determined based on the matching expectation information of the first user.

In some embodiments, after the first virtual object and the at least one second virtual object sit together in (are bound to) the first virtual multi-user seat, the first user interface may be switched to the second user interface, that is, a scene with the virtual learning space as the display subject is switched to a scene with the first virtual multi-user seat as the display subject, and this is not limited. In the scene of the second user interface in which the virtual multi-user seat is the display subject, the first virtual object and the at least one second virtual object sit together in one virtual multi-user seat.

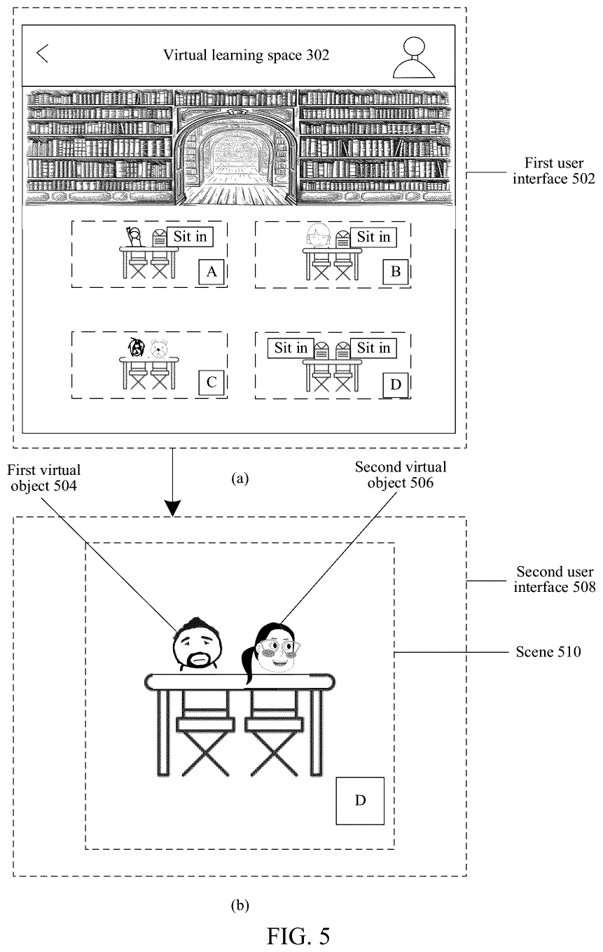

Further, refer to FIG. 5 based on the scene shown in FIG. 3. For example, a first user interface 502 with the virtual learning space 302 as a display subject is shown in FIG. 5(a). Further, as shown in FIG. 5(b), after a first virtual object 504 and a second virtual object 506 sit together in a first virtual multi-user seat (a virtual multi-user seat D), the first user interface 502 is switched to a second user interface 508 with the first virtual multi-user seat as a display subject (that is, the second user interface is generated and outputted), and a scene 510 in which the first virtual object 504 and the second virtual object 506 sitting together in the virtual multi-user seat D is displayed in the second user interface 508.

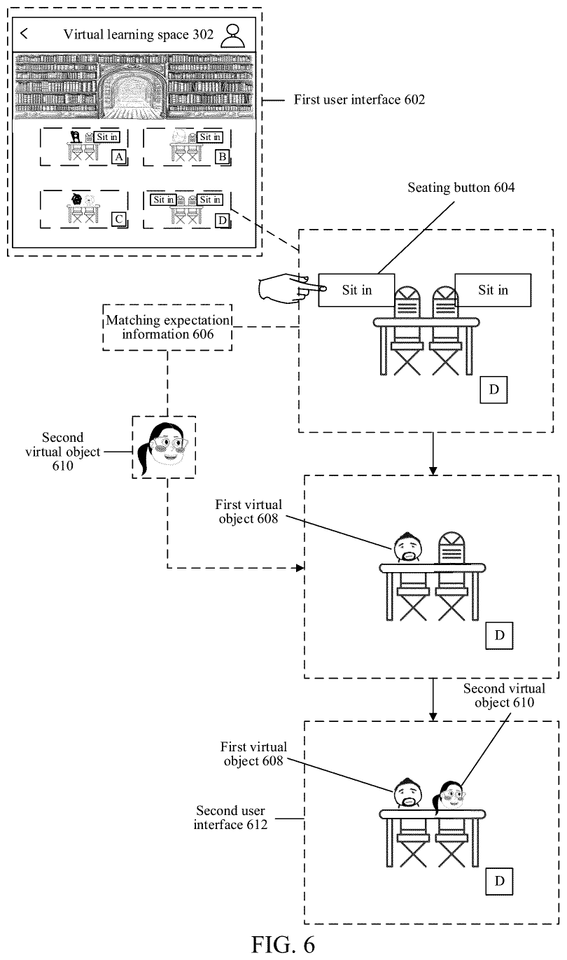

Further, refer to FIG. 6 based on the scene shown in FIG. 3. For example, a seating button 604 is displayed on a first user interface 602 associated with the virtual learning space 302. The first user interface 602 is an interface before a first user joins the virtual learning space 302, and the virtual learning space 302 includes a virtual multi-user seat (for example, the virtual multi-user seat D) that allows at least two virtual objects to sit in together. In response to a seating request triggered for the seating button 604, matching expectation information 606 set by the first user is obtained. The matching expectation information 606 set by the first user is configured for matching expectation information corresponding to a virtual object sitting together with a first virtual object 608 in the virtual multi-user seat and the first virtual object 608 is a virtual character of the first user. A second user interface 612 is generated and outputted. In the second user interface, the first virtual object 608 and at least one second virtual object 610 sit together in the virtual multi-user seat. The second virtual object 610 is the virtual object obtained after matching is performed based on the matching expectation information 606 set by the first user.

In an example, the second user interface includes at least one of the following:
duration for which the first virtual object and the at least one second virtual object are jointly bound to the first virtual multi-user seat, that is, duration for which the two objects sit together in a same virtual multi-user seat;
duration for which the first virtual object is bound to any virtual multi-user seat alone, that is, duration for which the first virtual object sits alone in a virtual multi-user seat;
duration for which the at least one second virtual object is respectively bound to any virtual multi-user seat alone, that is, duration for which the at least one second virtual object sits alone in a virtual multi-user seat;
historical information of the first virtual object in the virtual learning space; and
historical information of the at least one second virtual object in the virtual learning space.

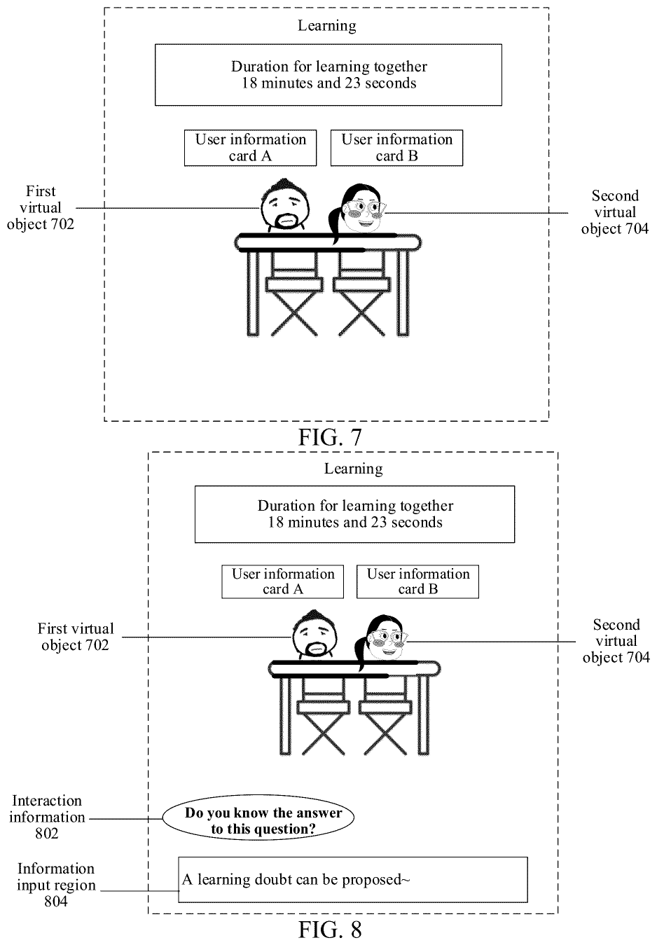

In some embodiments, as shown in FIG. 7, the second user interface further displays duration for learning together (duration for sitting together) of a first virtual object 702 and a second virtual object 704 as “18 minutes and 23 seconds”, a user information card A, and a user information card B. The user information card A may display, but is not limited to, duration for which the first virtual object 702 sits alone in a virtual multi-user seat, historical information of the first virtual object 702 in the virtual learning space, and the like. Similarly, the user information card B may display, but is not limited to, duration for which the second virtual object 704 sits alone in a virtual multi-user seat, historical information of the second virtual object 704 in the virtual learning space, and the like.

In an example, the second user interface further includes at least one of the following:
interaction information of the first virtual object and the at least one second virtual object; and
an information input region, configured for triggering generation of the interaction information.

In some embodiments, refer to FIG. 8 based on the scene shown in FIG. 7. The second user interface further displays the duration for learning together (duration for sitting in a same virtual multi-user seat) of the first virtual object 702 and the second virtual object 704 as “18 minutes and 23 seconds”, the user information card A, and the user information card B. The user information card A may display, but is not limited to, the historical information of the first virtual object 702 in the virtual learning space, and the like. Similarly, the user information card B may display, but is not limited to, the historical information of the second virtual object 704 in the virtual learning space, and the like.

In addition, the second user interface further displays interaction information 802 generated after the first virtual object 702 and the second virtual object 704 sit in the same virtual multi-user seat, and an information input region 804 (displayed with “a learning doubt can be proposed” and configured for prompting that this is an input region for the interaction information 802). The information input region 804 is configured for triggering generation of the interaction information 802.

In an example, after the information input region is displayed, the method further includes:
in response to an input request triggered for the information input region, displaying an information interaction interface, where the information interaction interface is an interface for information interaction between the first virtual object and the at least one second virtual object; and
in response to an output request triggered on the information interaction interface for target information, displaying the target information on the information interaction interface, and displaying an input source of the target information, where the input source is the first user.

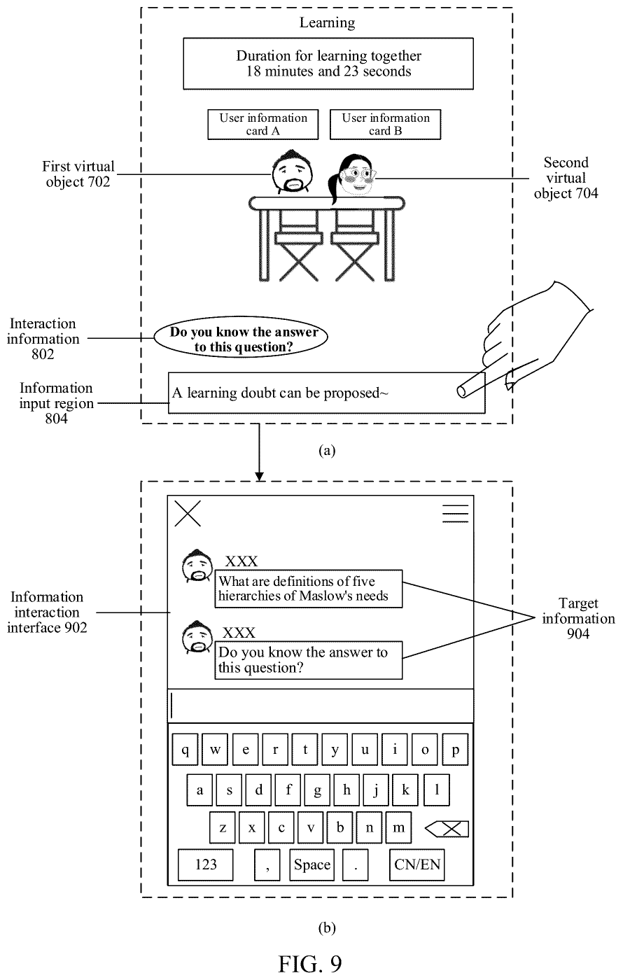

Further, refer to FIG. 9 based on the scene shown in FIG. 8. For example, as shown in FIG. 9(a), an input request triggered for the information input region 804 is obtained. Further, as shown in FIG. 9(b), an information interaction interface 902 is displayed in response to the input request. The information interaction interface 902 is an interface for information interaction between the first virtual object 702 and the second virtual object 704. In response to an output request triggered on the information interaction interface 902 for target information 904, the target information 904 (for example, “what are definitions of five hierarchies of Maslow's needs” and “do you know the answer to this question”) is displayed on the information interaction interface 902, and an input source of the target information 904 (for example, an avatar of the first virtual object 702 and a name of the first user) is displayed.

In an example, the method further includes:
in response to that no information about the at least one second user matching the matching expectation information set by the first user is obtained, generating and outputting a third user interface including the first virtual object, where the first virtual object is bound to a second virtual multi-user seat alone.

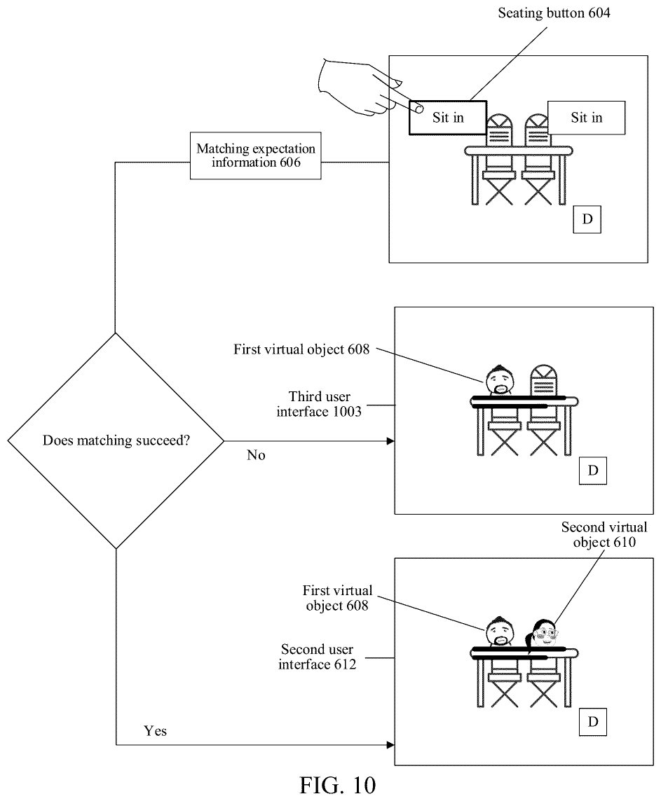

Further, refer to FIG. 10 based on the scene shown in FIG. 6. For example, after matching is performed based on the matching expectation information 606, it is determined whether the matching succeeds. If yes, a second user interface 612 in which the first virtual object 608 and the second virtual object 610 sitting together in a first virtual multi-user seat is displayed. If no, a third user interface 1003 in which the first virtual object 608 sitting alone in a second virtual multi-user seat is displayed.

In this embodiment of this disclosure, when the at least one second virtual object is successfully obtained after the matching is performed based on the matching expectation information, the second user interface in which the first virtual object and the at least one second virtual object sitting together in the first virtual multi-user seat is displayed. When the at least one second virtual object is not obtained after the matching is performed based on the matching expectation information, the third user interface in which the first virtual object sitting alone in the second virtual multi-user seat is displayed. In this way, a corresponding user interface can be provided when the matching succeeds or fails, thereby achieving a technical effect of improving an error-tolerant rate of a matching mechanism.

In an example, the method further includes at least one of the following:
generating a first prompt label, and displaying the first prompt label in a region associated with the second virtual multi-user seat, where the first prompt label is configured for displaying the matching expectation information set by the first user;
generating a second prompt label, and displaying the second prompt label in the region associated with the second virtual multi-user seat, where the second prompt label is configured for displaying associated identity information of the first user; and
generating a third prompt label, and displaying the third prompt label in the region associated with the second virtual multi-user seat, where the third prompt label is configured for displaying expected identity information inputted by the first user. The expected identity information is identity information corresponding to a virtual object expected by the first user to sit together with the first virtual object in the second virtual multi-user seat.

In some embodiments, the region associated with the second virtual multi-user seat may include, but is not limited to, a region on the second virtual multi-user seat, a region below the second virtual multi-user seat, a region above the second virtual multi-user seat, and the like. A requirement of the available second virtual multi-user seat can be more visually displayed by displaying the prompt labels, thereby improving a success rate of matching.

The third prompt label is displayed in the region associated with the second virtual multi-user seat. The third prompt label is configured for displaying the expected identity information inputted by the first user. The expected identity information is the identity information corresponding to the virtual object expected by the first user to sit together with the first virtual object in the second virtual multi-user seat. For example, when the first user expects to sit together with a virtual object having a good Chinese grade in the second virtual multi-user seat, the third prompt label may display, but is not limited to, information such as “hope to find a desk mate” and “Chinese grade is good”.

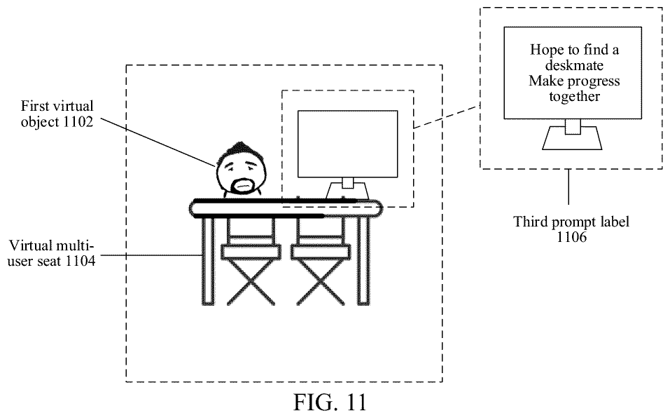

Further, for example, as shown in FIG. 11, a first virtual object 1102 sits alone in a virtual multi-user seat 1104, and a third prompt label 1106 is displayed in a region associated with the virtual multi-user seat 1104 (on the virtual multi-user seat 1104). The third prompt label 1106 is configured for displaying expected identity information inputted by a first user, such as “hope to find a desk mate” and “make progress together”. In other words, the expected identity information is that the first user expects to sit in a same table with a virtual object with whom they can “make progress together”.

In an example, the method further includes:
in response to a third virtual object sitting in the second virtual multi-user seat, generating and outputting a fourth user interface including the first virtual object and the third virtual object. The first virtual object and the third virtual object sit together in the second virtual multi-user seat in the fourth user interface.

In some embodiments, after the first virtual object sits alone in the second virtual multi-user seat, any virtual object may directly sit in the second virtual multi-user seat and become a desk mate of the first virtual object. In addition, to avoid a malicious sharing table behavior, a user may be allowed, but is not limited to, to report a virtual object sharing table with, and record a specific mater of malicious sharing table.

In an example, the method further includes:
receiving a request from a fourth virtual object for requesting to be bound to the second virtual multi-user seat, and in response to that the first user indicates to accept the request from the fourth virtual object, generating and outputting a fifth user interface including the first virtual object and the fourth virtual object. The first virtual object and the fourth virtual object are jointly bound to the second virtual multi-user seat.

In this embodiment, after the first virtual object is bound to the second virtual multi-user seat alone, other virtual objects all need to obtain instruction and consent of the first user before sitting in the second virtual multi-user seat. In other words, the first user is given control permission for the second virtual multi-user seat.

In an example, the method further includes:
receiving a request from a fifth virtual object for requesting to be bound to the second virtual multi-user seat, and in response to that an information similarity degree between matching expectation information of the fifth virtual object and the matching expectation information set by the first user is greater than or equal to a first preset threshold, generating and outputting a sixth user interface including the first virtual object and the fifth virtual object. The first virtual object and the fifth virtual object are jointly bound to the second virtual multi-user seat.

In some embodiments, in response to the seating request triggered for the seating button, first matching is performed based on the matching expectation information set by the first user, and after the first matching fails, the second user interface in which the first virtual object sitting alone in the virtual multi-user seat is displayed. Then, second matching and/or third matching may be further performed, and this is not limited. The second matching may be understood as, but is not limited to, that instant matching is performed once each time a virtual object requests to sit in the virtual multi-user seat. The third matching may be understood as, but is not limited to, that after the first virtual object sits alone in the virtual multi-user seat, matching and determining are still performed on virtual objects within a preset range until the first user instructs to stop matching or the at least one second virtual object is matched.

In an example, the third user interface further includes a seat sharing button, and the method further includes:
in response to a seat sharing request triggered for the seat sharing button, displaying at least one alternative user;
in response to a sharing request triggered for a target alternative user in the at least one alternative user, transmitting seat sharing information to a terminal associated with the target alternative user, where the seat sharing information is configured for inviting the target alternative user to sit together with the first virtual object in the second virtual multi-user seat; and
receiving request feedback information returned by the terminal associated with the target alternative user, and in response to that the request feedback information indicates that the target alternative user accepts the sharing, generating and outputting a seventh user interface including the first virtual object and the target alternative user. The first virtual object and a virtual object corresponding to the target alternative user are jointly bound to the second virtual multi-user seat.

In some embodiments, the at least one to-be-shared alternative user may be, but is not limited to, a registered user of an application program corresponding to the virtual learning space, or may be, but is not limited to, a registered user of an associated application program other than the application program corresponding to the virtual learning space. For example, a virtual seat is shared to a user that is in a chat application and that is in a same group chat with the first user or is a friend of the first user.

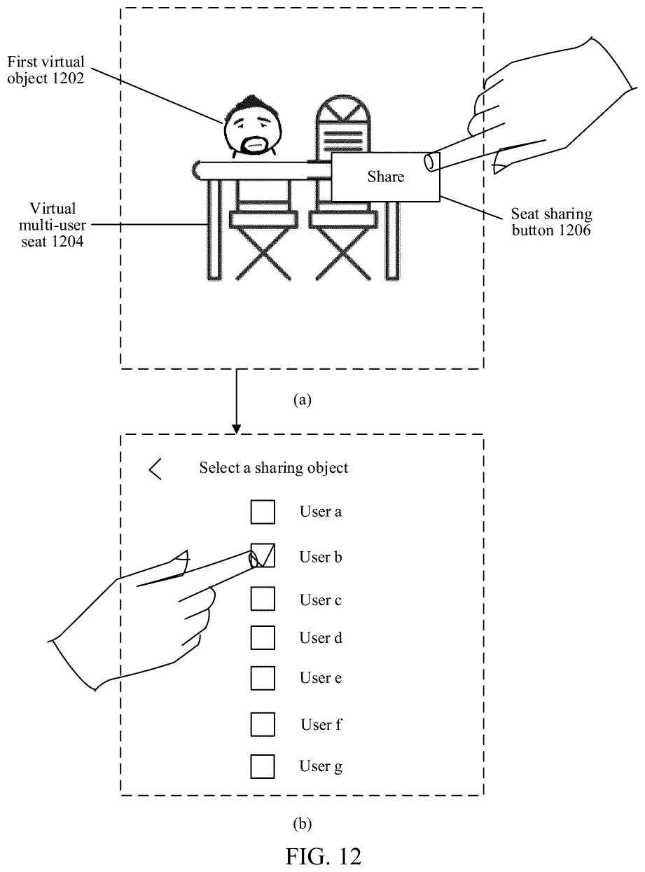

Further, refer to FIG. 12. For example, as shown in FIG. 12(a), a seat sharing button 1206 is displayed in a third user interface. Further, as shown in FIG. 12(b), in response to a seat sharing request triggered for the seat sharing button 1206, at least one to-be-shared alternative user, such as a “user a”, a “user b”, a “user c”, or a “user d” is displayed. Then, in response to a sharing request triggered by a target alternative user (such as the “user b”) in the at least one to-be-shared alternative user, seat sharing information is sent to a terminal associated with the target alternative user. The seat sharing information is configured for inviting the target alternative user to sit together with a first virtual object 1202 in a virtual multi-user seat 1204. Request feedback information returned by the terminal associated with the target alternative user is received, and in response to that the request feedback information indicates that the target alternative user accepts the sharing, a seventh user interface including the first virtual object 1202 and the target alternative user is generated and outputted.

In an example, the setting interface includes at least two candidate labels, and the method further includes:
in response to a selecting request triggered for a target candidate label in the at least two candidate labels, determining expectation information corresponding to the target candidate label as the matching expectation information set by the first user.

In some embodiments, to improve setting efficiency of the matching expectation information, a plurality of candidate labels may be provided for the user to select, and this is not limited.

In an example, the setting interface further includes a to-be-inputted region, the matching expectation information set by the first user includes first expectation information and second expectation information, and
the method further includes:
in response to a selecting request triggered for a target candidate label in at least two candidate labels, determining expectation information corresponding to the target candidate label as the first expectation information set by the first user; and
in response to an information input request triggered for the to-be-inputted region, obtaining matching reference information inputted by the user, and determining the matching reference information as the second expectation information set by the first user.

In some embodiments, the matching expectation information set by the first user includes the first expectation information, that is, matching is performed by using the first expectation information set by the first user. The matching expectation information set by the first user may not include the second expectation information, that is, matching is not performed by using the second expectation information. Alternatively, both the first expectation information and the second expectation information are used as the matching expectation information set by the first user, and different matching weights are assigned to the first expectation information and the second expectation information.

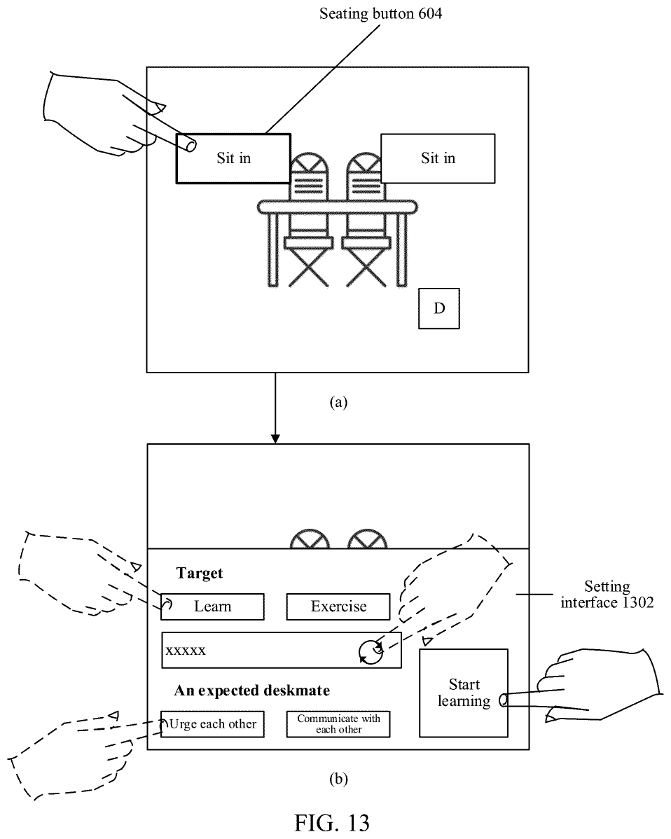

Further, refer to FIG. 13 based on the scene shown in FIG. 6. For example, as shown in FIG. 13(a), a seating request is obtained. Further, as shown in FIG. 13(b), in response to the seating request, a setting interface 1302 is displayed, and at least two candidate labels (for example, a target such as “learning” or “exercising”, and an expected desk mate that can “urge each other” or “communicate with each other”), and a to-be-inputted region are displayed on the setting interface 1302. In response to a selecting request, expectation information corresponding to a target candidate label (for example, the selected “learning” or “urge each other”) is determined as first expectation information set by a first user, for example, “learning” or “urge each other”. The matching expectation information set by the first user includes first expectation information. In response to an information input request triggered for the to-be-inputted region, matching reference information inputted by the user is obtained, and the matching reference information is determined as second expectation information set by the first user. Further, as shown in FIG. 13(b), in response to a selected operation performed on a virtual button “start learning”, seating matching for a virtual object is performed.

In an example, the method further includes:
in response to that no information about the at least one second user matching the matching expectation information set by the first user is obtained, determining a virtual character of artificial intelligence as a second virtual object.

In some embodiments, to improve a success rate of matching the second virtual object, the virtual character of the artificial intelligence may be determined as the second virtual object when that at least one target second user is not determined from a plurality of candidate users, and this is not limited.

A quantity of users in virtual learning space usually cannot be guaranteed to be a high value, and consequently, the success rate of matching the second virtual object cannot be guaranteed. This is a poor phenomenon for user experience. Further, to resolve the problem, a virtual character of a real user may be replaced with, but is not limited to, the virtual character of the artificial intelligence. In addition to providing a similar image companion, the virtual character of the artificial intelligence may further perform smooth information interaction with a user by using a natural language processing technology, thereby providing the user with a desk mate service similar to that with the real user.

In an example, a plurality of candidate users associated with the virtual learning space includes at least one of the following:
a user in an online state in the virtual learning space; and
a user in an offline state and satisfying an offline matching condition in the virtual learning space.

A quantity of users in a virtual self-learning room usually cannot be guaranteed to be a high value, and consequently, a success rate of matching a second virtual object cannot be guaranteed. Further, to resolve the problem, both the user in the online state and the user in the offline state may be used as selection objects of the candidate users, to expand a selection range of the candidate users, and this is not limited, thereby improving the success rate of matching the second virtual object.

In an example, the offline matching condition includes:
an interval between last online time in the virtual learning space and current time being less than a third preset threshold.

In some embodiments, in a process of performing matching on the user in the offline state, to improve a success rate of matching, the matching may be performed on, but is not limited to, a user who is online recently but is currently in the offline state.

In an example, in response to that the at least one second user determined from the candidate users includes the user in the offline state, the method further includes:
transmitting seating invitation information to a terminal associated with the user in the offline state, where the seating invitation information is configured for inviting the user in the offline state to sit together with the first virtual object in the virtual multi-user seat; and
receiving request feedback information returned by the terminal associated with the user in the offline state, and in response to that request feedback information indicates that the user accepts the invitation, generating and outputting the second user interface.

In an example, the seating button being displayed on the first user interface associated with the virtual learning space includes:
displaying a first seating button on the first user interface, where the first seating button is configured to trigger a seating request for any virtual multi-user seat in the virtual learning space; and
displaying a second seating button on the first user interface at a region associated with each virtual multi-user seat, where the second seating button is configured to trigger a seating request for a corresponding virtual multi-user seat.

In some embodiments, as shown in FIG. 4, a first seating button (the seating button 406) is displayed in the user interface 402. The first seating button is configured to trigger a seating request corresponding to any virtual multi-user seat included in the virtual learning space.

In some embodiments, as shown in FIG. 5, a second seating button is displayed at the region associated with each virtual multi-user seat (for example, the virtual multi-user seat D) on the user interface. The second seating button is configured to trigger a seating request for the virtual multi-user seat corresponding to the second seating button.

In an example, the method further includes:
generating and outputting a main interface, and displaying a virtual-learning-space identifier on the main interface, where the virtual-learning-space identifier is a trigger identifier for entering the virtual learning space; and
in response to a selected operation performed on the trigger identifier of the virtual learning space, generating and outputting the first user interface.

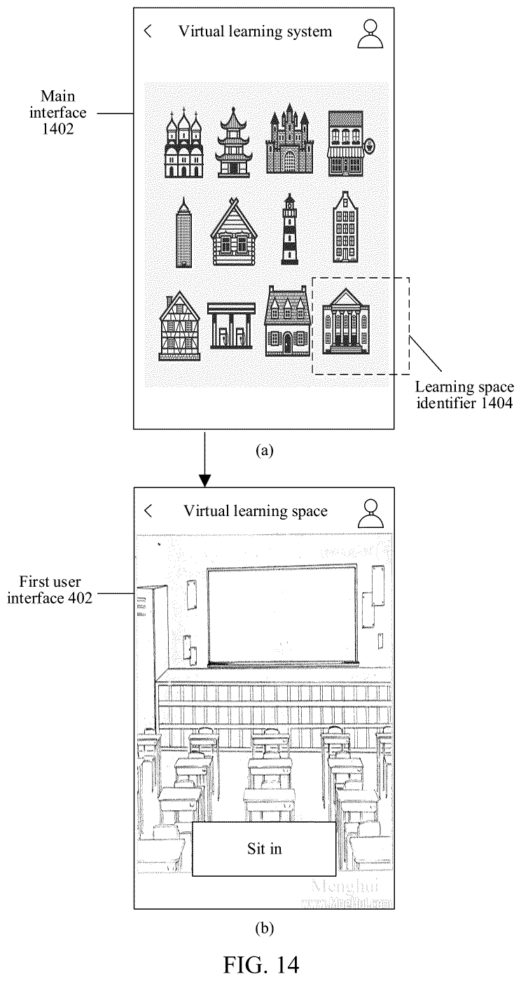

Further, refer to FIG. 14 based on the scene shown in FIG. 4. For example, as shown in FIG. 14(a), a main interface 1402 is generated and outputted, and at least one virtual-learning-space identifier is displayed on the main interface. The virtual-learning-space identifier is a trigger identifier for entering virtual learning space, and the at least one virtual-learning-space identifier includes the trigger identifier (a learning space identifier 1404) of the virtual learning space. Further, as shown in FIG. 14(b), in response to a selected operation performed on the trigger identifier of the virtual learning space, the first user interface 402 is generated and outputted.

In some embodiments, the method for implementing a virtual learning system may include, but is not limited to, a procedure in which a desk mate is matched by a system, a procedure to exit learning, and the like. For the procedure in which the desk mate is matched by the system, specific operations are as follows:
S1: There is a library (that is, virtual learning space) identifier entrance in a virtual learning system, and the library can be entered by tapping the identifier.
S2: In the library, a setting interface for setting a target and an expectation may be invoked by tapping a “tap-for-seat” button.
S3: A target and an expected desk mate may be set on the setting interface, where a personalized signature copywriting within 12 words may be customized after the target is selected, and the set target information is configured for matching a desk mate.
S4: After a start learning button is tapped, corresponding interface information is displayed, where when there is no expected desk mate, only a user information card is displayed and a communication input box is not displayed; and when there is an expected desk mate, duration for learning together, respective information, and the communication input box are displayed.

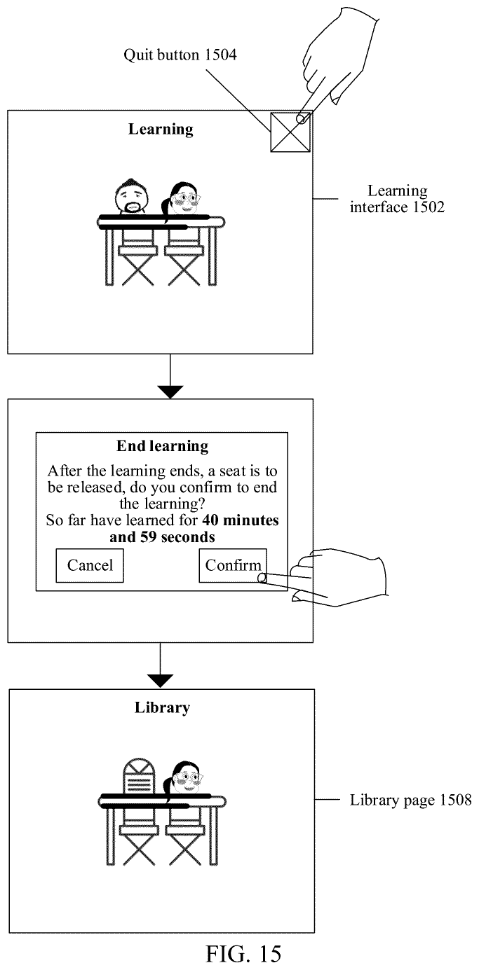

The procedure to exit learning is specifically shown in FIG. 15. A quit button 1504 in a top right corner of learning interface 1502 is tapped, an end learning pop-up window 1506 is displayed, and current learning duration, for example, “40 minutes and 59 seconds”, is displayed in the end learning pop-up window 1506. Further, after the learning is exited, an interface being returned to a library page 1508 is determined.

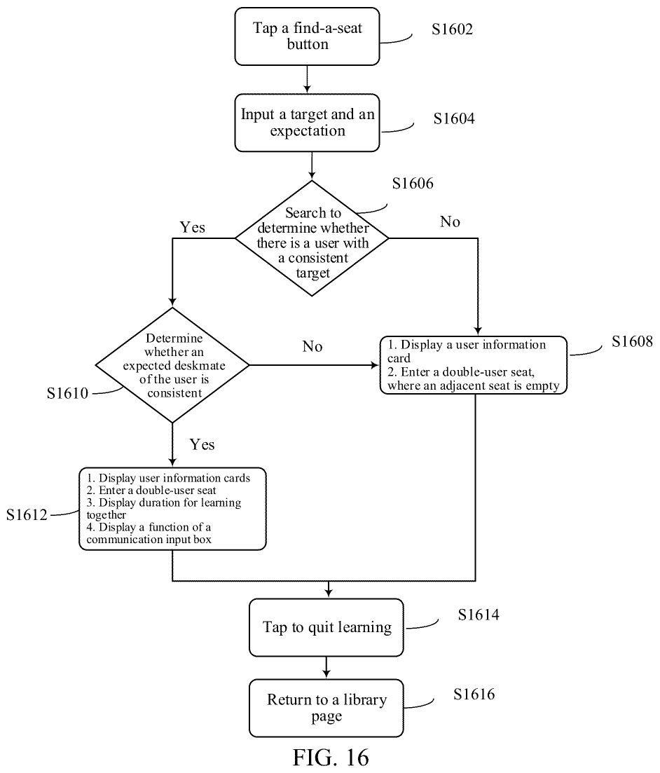

Further, for example, a procedure after a user enters a seat is shown in FIG. 16, and specific operations are as follows:
Operation S1602: Tap a find-a-seat button.
Operation S1604: Input a target and an expectation.
Operation S1606: Search to determine whether there is a user with a consistent target, and if yes, operation S1610 is performed; or if no, operation S1608 is performed.
Operation S1608: Display a user information card, and enter a double-user seat, where an adjacent seat is empty.
Operation S1610: Determine whether an expected desk mate of the user is consistent, and if yes, operation S1612 is performed; or if no, operation S1608 is performed.
Operation S1612: Display user information cards, enter a double-user seat, display duration for learning together, and display a function of communication input box.
Operation S1614: Tap to quit learning.
Operation S1616: Return to a library page.

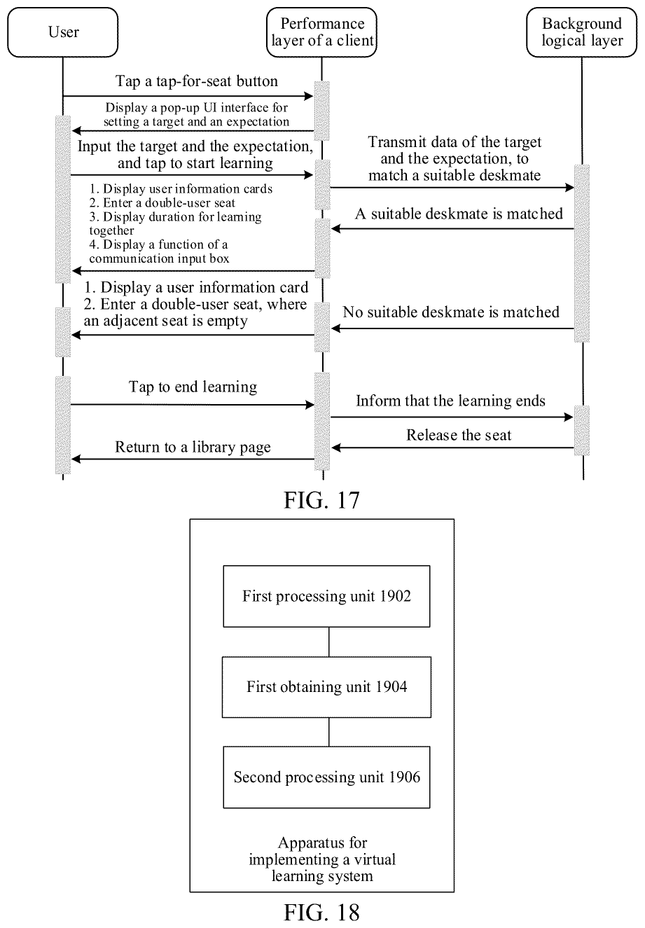

In some embodiments, a diagram of a specific time sequence among a user, a performance layer of a client, and a background logical layer is shown in FIG. 17. For specific execution operations, refer to the foregoing explanation of FIG. 16. For example, the user taps a tap-for-seat button, and the performance layer of the client displays a pop-up UI interface for setting a target and an expectation. Then, the user inputs the target and the expectation on the UI interface, and taps to start learning.

Further, the performance layer of the client transmits data of the target and the expectation to the background logical layer, to match a suitable desk mate. After the background logical layer feeds back that a suitable desk mate is matched, the performance layer of the client displays user information cards, displays a picture in which the users enter a double-user seat, displays duration for learning together, displays a function of communication input, and the like. On the contrary, after the background logical layer feeds back that no suitable desk mate is matched, the performance layer of the client displays a user information card and a picture in which the user enters a double-user seat where an adjacent seat is empty.

In addition, after the user taps to end learning, the performance layer of the client informs the background logical layer that the learning ends. The background logical layer returns an instruction of releasing the seat. Then, the performance layer of the client displays a page on which the user returns to the library.

This embodiment provides an implementation for a virtual learning system, to enable two users to learn together in a virtual scene.

In a specific implementation of this disclosure, relevant data such as user information is involved. When the foregoing embodiments of this disclosure are applied to a specific product or technology, user permission or user agreement is required, and collection, use and processing of the relevant data need to comply with relevant laws, regulations, and standards of relevant countries and regions.

For case of description, the foregoing method embodiments are described as combinations of a series of actions. However, a person skilled in the art is to know that, this disclosure is not limited to any described order of the actions, because some operations may be performed in another order or simultaneously according to this disclosure.

According to another aspect of the embodiments of this disclosure, an apparatus for implementing a virtual learning system and configured to perform the foregoing method for implementing a virtual learning system is further provided. As shown in FIG. 18, the apparatus includes:
a first processing unit 1902, configured to: in response to a seating request triggered by a first user on a seating button on a first user interface, display a setting interface configured for setting matching expectation information, where the first user interface is a user interface associated with virtual learning space provided by a virtual learning system, and the virtual learning space includes a virtual multi-user seat that allows to be bound to at least two virtual objects;
a first obtaining unit 1904, configured to obtain matching expectation information inputted by the first user on the setting interface, and obtain information about at least one second user matching the matching expectation information set by the first user, where the at least one second user is a user that is searched from candidate users associated with the virtual learning space and that matches the matching expectation information inputted by the first user; and
a second processing unit 1906, configured to: in response to the obtained information about the at least one second user, generate and output a second user interface including a first virtual object corresponding to the first user and at least one second virtual object corresponding to the at least one second user, where the first virtual object and the at least one second virtual object both are bound to a first virtual multi-user seat.

For specific embodiments, refer to the example shown in the foregoing method for implementing a virtual learning system, and details are described in this example.

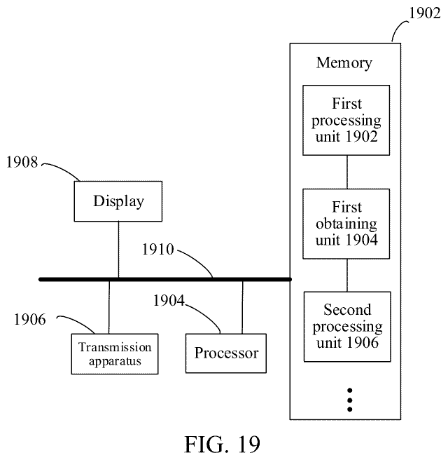

According to still another aspect of the embodiments of this disclosure, an electronic device for performing the foregoing method for implementing a virtual learning system is further provided. As shown in FIG. 19, the electronic device includes a memory 1902 and a processor 1904. The memory 1902 has a computer program stored therein, and the processor 1904 is configured to perform operations in any one of the foregoing method embodiments through the computer program.

A person of ordinary skill in the art may understand that, the structure shown in FIG. 19 is only an example. The electronic device may be a terminal device such as a smartphone (for example, an Android mobile phone or an iOS mobile phone), a tablet computer, a palmtop computer, a mobile Internet device (MID), or a PAD. FIG. 19 does not limit the structure of the electronic device. For example, the electronic device may further include more or fewer components (such as a network interface) than those shown in FIG. 19, or has a configuration different from that shown in FIG. 19.

The memory 1902, such as a non-transitory computer-readable storage medium, may be configured to store a software program and a module, for example, program instructions/modules corresponding to the method and apparatus for implementing a virtual learning system in the embodiments of this disclosure. Processing circuitry, such as the processor 1904 runs the software program and the module stored in the memory 1902, to implement various functional disclosures and data processing, that is, implement the foregoing method for implementing a virtual learning system. The memory 1902 may include a high speed random access memory, and may also include a non-volatile memory, for example, one or more magnetic storage apparatuses, a flash memory, or another non-volatile solid-state memory. In some embodiments, the memory 1902 may further include memories remotely disposed relative to the processor 1904, and the remote memories may be connected to a terminal through a network. Examples of the network include, but are not limited to, the Internet, an intranet, a local area network, a mobile communication network, and a combination thereof. The memory 1902 may be specifically configured to, but is not limited to, store information such as matching expectation information. For example, as shown in FIG. 19, the memory 1902 may include, but is not limited to, the first processing unit 1902, the first obtaining unit 1904, and the second processing unit 1906 that are in the foregoing apparatus for implementing a virtual learning system. In addition, the memory 1902 may include, but is not limited to, another module unit in the foregoing apparatus for implementing a virtual learning system, and details are not described in this example.

A transmission apparatus 1906 is configured to receive or transmit data through a network. Specific examples of the network may include a wired network and a wireless network. In an example, the transmission apparatus 1906 includes a network interface controller (NIC), and the network interface controller may be connected to another network device and a router through a network cable, to communicate with the Internet or a local area network. In an example, the transmission apparatus 1906 is a radio frequency (RF) module, and is configured to communicate with the Internet in a wireless manner.

In addition, the foregoing electronic device further includes: a display 1908, configured to display the information such as the matching expectation information; and a connection bus 1910, configured to connect module parts in the electronic device.

In another embodiment, the foregoing terminal device or server may be a node in a distributed system. The distributed system may be a blockchain system, and the blockchain system may be a distributed system formed by connecting a plurality of nodes in a form of network communication. The nodes may form a peer to peer (P2P) network, and any form of computing device, for example, the electronic device such as the server or the terminal, may become a node in the blockchain system by joining the peer to peer network.

According to an aspect of this disclosure, a computer program product is provided. The computer program product includes computer programs/instructions, and the computer programs/instructions include program code configured for performing the method shown in the flowchart. In such an embodiment, the computer program may be downloaded and installed from a network through a communication part, and/or installed from a removable medium. When the computer program is executed by a central processing unit, functions provided in this embodiment of this disclosure are executed.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Sequence numbers of the foregoing embodiments of this disclosure are merely for description purpose but do not indicate the preference of the embodiments.

A computer system of the electronic device is merely an example, and does not constitute any limitation on functions and use ranges of the embodiments of this disclosure.

The computer system includes a central processing unit (CPU). The CPU may perform various appropriate actions and processing based on a program stored in a read-only memory (ROM) or a program loaded from a storage portion into a random access memory (RAM). The random access memory further stores various programs and data required for operating the system. The central processing unit, the read-only memory, and the random access memory are connected to each other through a bus. An input/output (I/O) interface is also connected to the bus.

The following components are connected to the input/output interface: an input part including a keyboard, a mouse, or the like, an output part including a cathode ray tube (CRT), a liquid crystal display (LCD), a speaker, or the like, a storage part including a hard disk, or the like, and a communication part including a network interface card such as a local area network or a modem. The communication part performs communication processing by using a network such as the Internet. A drive is also connected to the input/output interface as required. A removable medium, such as a magnetic disk, an optical disc, a magneto-optical disk, or a semiconductor memory, is installed on the drive as required, so that a computer program read from the removable medium is installed into the storage part as required.

Particularly, according to the embodiments of this disclosure, the processes described in the method flowcharts may be implemented as computer software programs. For example, an embodiment of this disclosure includes a computer program product, the computer program product includes a computer program carried on a computer-readable medium, and the computer program includes program code configured for performing the method shown in the flowchart. In such an embodiment, the computer program may be downloaded and installed from a network through a communication part, and/or installed from a removable medium. When the computer program is executed by a central processing unit, functions of this disclosure are executed.

According to an aspect of this disclosure, a computer-readable storage medium is provided. A processor of a computer device reads computer instructions from the computer-readable storage medium. The processor executes the computer instructions to enable the computer device to perform the method provided in the foregoing optional implementations.

In some embodiments, a person of ordinary skill in the art may understand that all or part of the operations of the methods in the foregoing embodiments may be implemented by a program instructing hardware relevant to a terminal device. The program may be stored in a computer-readable storage medium, and the storage medium may include: a flash drive, a read-only memory, a random access memory, a magnetic disk, an optical disc, and the like.

Sequence numbers of the foregoing embodiments of this disclosure are merely for description purpose but do not indicate the preference of the embodiments.

When the integrated unit in the foregoing embodiments is implemented in a form of a software functional unit and sold or used as an independent product, the integrated unit may be stored in the foregoing computer-readable storage medium. Based on such an understanding, the examples may be implemented in a form of a software product. The computer software product is stored in a storage medium and includes several instructions used to enable one or more computer devices (which may be a personal computer, a server, a network device, or the like) to perform all or some of the operations of the methods described in the embodiments of this disclosure.

In the foregoing embodiments of this disclosure, descriptions of the embodiments have different emphases. For a part that is not described in detail in one embodiment, refer to related descriptions in other embodiments.

In the several embodiments provided in this disclosure, the disclosed client may be implemented in another manner. The described apparatus embodiment is merely exemplary. For example, the unit division is merely logical function division and may have other division manners in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the units or modules may be implemented in electronic or other forms.

The units described as separate parts may or may not be physically separate, and parts displayed as units may or may not be physical units, may be located in one position, or may be distributed on a plurality of network units. A part of or all of the units may be selected based on an actual need to achieve the objectives of the solutions of the embodiments.

In addition, functional units in the embodiments of this disclosure may be integrated into one processing unit, or each of the units may exist alone physically, or two or more units are integrated into one unit. The integrated unit may be implemented in a form of hardware, or may be implemented in a form of a software function unit.

The foregoing descriptions are merely examples of this disclosure. A person of ordinary skill in the art may further make several improvements and modifications without departing from the principle of this disclosure. These improvements and modifications shall fall within the protection scope of this disclosure.

What is claimed is:

1. A virtual learning method, the method comprising:
displaying a setting interface for inputting information when a seating request is triggered by a first user on a first user interface, the first user interface being associated with a virtual learning system;
obtaining information about at least one second user that is associated with the virtual learning system; and
when the at least one second user is matched to the inputted information input by the first user, displaying a second user interface including a first virtual object corresponding to the first user and at least one second virtual object corresponding to the at least one second user, the first virtual object and the at least one second virtual object both being bound to a first virtual multi-user seat.

2. The method according to claim 1, wherein the second user interface indicates at least one of:
duration for which the first virtual object and the at least one second virtual object are jointly bound to the first virtual multi-user seat;
duration for which the first virtual object is bound to any virtual multi-user seat alone;
duration for which each of the at least one second virtual object is respectively bound to any virtual multi-user seat alone;
historical information of the first virtual object in the virtual learning system; or
historical information of the at least one second virtual object in the virtual learning system.

3. The method according to claim 1, further comprising:
displaying an information interaction interface when an information input request is triggered in the second user interface, wherein interaction information between the first virtual object and the at least one second virtual object is input via the information interaction interface; and
displaying target information on the information interaction interface when an output request is triggered on the information interaction interface, wherein the information input request is from the first virtual object.

4. The method according to claim 1, further comprising:
when no information about the at least one second user is obtained, displaying a third user interface in which the first virtual object is bound to a second virtual multi-user seat alone.

5. The method according to claim 4, further comprising:
displaying a first prompt label in a region associated with the second virtual multi-user seat, wherein the first prompt label displays the inputted information input by the first user;
displaying a second prompt label in the region associated with the second virtual multi-user seat, wherein the second prompt label displays identity information of the first user; or
displaying a third prompt label in the region associated with the second virtual multi-user seat, wherein the third prompt label displays identity information inputted by the first user, and the identity information corresponds to a virtual object to be bound with the first user to the second virtual multi-user seat.

6. The method according to claim 4, further comprising:
receiving a request from a third virtual object to be bound to the second virtual multi-user seat, and when the first user accepts the request from the third virtual object
displaying a fourth user interface that includes the first virtual object and the third virtual object, wherein the first virtual object and the third virtual object are bound to the second virtual multi-user seat.

7. The method according to claim 4, further comprising:
displaying at least one alternative user when a seat sharing element is selected by the first user in the third user interface;
transmitting a seat sharing request to a target alternative user when the target alternative user of the at least one alternative user is selected, wherein the seat sharing request is configured to invite the target alternative user to sit together with the first virtual object in the second virtual multi-user seat; and
receiving feedback information from the target alternative user, and when the feedback information indicates that the target alternative user accepts the sharing,
displaying a fifth user interface that includes the first virtual object and a target virtual object of the target alternative user, wherein the first virtual object and the target virtual object corresponding to the target alternative user are bound to the second virtual multi-user seat.

8. The method according to claim 1, wherein
the at least one second user is in an online state in the virtual learning system.

9. The method according to claim 1, wherein
the at least one second user is in an offline state and an interval since the at least one second user was last online is less than a threshold.

10. The method according to claim 9, when the at least one second user is in the offline state, the method further comprises:
transmitting the seating request to the at least one second user in the offline state, wherein the seating request is configured to invite the at least one second user in the offline state to sit together with the first virtual object in the first virtual multi-user seat;
receiving feedback information from the at least one second user in the offline state; and
displaying the second user interface when the feedback information indicates that the at least one second user in the offline state accepted the seating request.

11. An information processing apparatus, comprising:
processing circuitry configured to:
display a setting interface for input information when a seating request is triggered by a first user on a first user interface, the first user interface being associated with a virtual learning system;
obtain information about at least one second user that is associated with the virtual learning system; and
when the at least one second user is matched to the inputted information input by the first user,
display a second user interface including a first virtual object corresponding to the first user and at least one second virtual object corresponding to the at least one second user, the first virtual object and the at least one second virtual object both being bound to a first virtual multi-user seat.

12. The information processing apparatus according to claim 11, wherein the processing circuitry is configured to:
display an information interaction interface when an information input request is triggered in the second user interface, wherein interaction information between the first virtual object and the at least one second virtual object is input via the information interaction interface; and
display target information on the information interaction interface when an output request is triggered on the information interaction interface, wherein the information input request is from the first virtual object.

13. The information processing apparatus according to claim 11, wherein
the at least one second user is in an online state in the virtual learning system.

14. The information processing apparatus according to claim 11, wherein
the at least one second user is in an offline state and an interval since the at least one second user was last online is less than a threshold.

15. The information processing apparatus according to claim 14, when the at least one second user is in the offline state, the processing circuitry is configured to:
transmit the seating request to the at least one second user in the offline state, wherein the seating request is configured to invite the at least one second user in the offline state to sit together with the first virtual object in the first virtual multi-user seat;
receive feedback information from the at least one second user in the offline state; and
display the second user interface when the feedback information indicates that the at least one second user in the offline state accepted the seating request.

16. A non-transitory computer-readable storage medium, storing instructions which when executed by a processor cause the processor to perform:
displaying a setting interface for inputting information when a seating request is triggered by a first user on a first user interface, the first user interface being associated with a virtual learning system;
obtaining information about at least one second user that is associated with the virtual learning system; and
when the at least one second user is matched to the inputted information input by the first user, displaying a second user interface including a first virtual object corresponding to the first user and at least one second virtual object corresponding to the at least one second user, the first virtual object and the at least one second virtual object both being bound to a first virtual multi-user seat.

17. The non-transitory computer-readable storage medium according to claim 16, wherein the instructions when executed by the processor further cause the processor to perform:
displaying an information interaction interface when an information input request is triggered in the second user interface, wherein interaction information between the first virtual object and the at least one second virtual object is input via the information interaction interface; and
displaying target information on the information interaction interface when an output request is triggered on the information interaction interface, wherein the information input request is from the first virtual object.

18. The non-transitory computer-readable storage medium according to claim 16, wherein the at least one second user in an online state in the virtual learning system.

19. The non-transitory computer-readable storage medium according to claim 16, wherein
the at least one second user is in an offline state and an interval since the at least one second user was last online is less than a threshold.

20. The non-transitory computer-readable storage medium according to claim 19, wherein, when the at least one second user is in the offline state, the instructions when executed by the processor further cause the processor to perform:
transmitting the seating request to the at least one second user in the offline state, wherein the seating request is configured to invite the at least one second user in the offline state to sit together with the first virtual object in the first virtual multi-user seat;
receiving feedback information from the at least one second user in the offline state; and
displaying the second user interface when the feedback information indicates that the at least one second user in the offline state accepted the seating request.
